(19) United States
(12) Patent Application Publication
(10) Pub. No.: US 2006/0057266 A1
(43) Pub. Date: Mar. 16, 2006

(54) Method for the production of coloured animal or human foodstuffs and corresponding device

(76) Inventors: Markus Meyer, Egnach (CH); Konrand Munz, Schoenenberg (CH); Stefan Rutishauser, St. Gallen (CH)

Correspondence Address: JORDAN AND HAMBURG LLP, 122 EAST 42ND STREET, SUITE 4000, NEW YORK, NY, 10168, US

(21) Appl. No.: 10/534,337

(22) PCT Filed: Dec. 17, 2003
(86) PCT No.: PCT/CH03/00828

§ 371 Date: Sep. 15, 2005

(30) Foreign Application Priority Data
Dec. 17, 2002 (DE) 102 59 203.9

(51) Int. Cl. A23L 1/27

(52) U.S. Cl. 426/516; 426/540

(57) ABSTRACT

A method and a device for the production of coloured animal or human foodstuffs and corresponding device, in particular, animal or human foodstuffs with two colours having clearly defined coloured regions. The above is achieved, whereby a product stream, preferably produced in an extruder, is divided into several independent part streams (depending on the number of colours) in a mixing run and each partial stream is mixed with a colour in a mixing chamber. The partial streams are mixed just before outlet nozzles on a nozzle plate, such that end products with clearly defined colour regions are produced after expansion and cutting.

The invention relates to a process for producing colored animal fodder or human food, particularly two-colored animal fodder or human food or also pharmaceutical or other industrial products according to the preamble of the claim. The invention also relates to a device for producing colored animal fodder or human food and industrial applications.

DE A 19754863 discloses a process and a device for producing colored pellets. This device has a first granulator to mold molten resin of one color into pellets and a second granulator to mold molten resin of another color into pellets. While the first granulator is connected to a discharge aperture, the second granulator is blocked, so that cleaning can be done quickly when the color is changed. The pellets contain only the color of the resin of the first or second granulator.

Producing colored pet food by extrusion is also known, but so far it has not been possible to achieve clear separations between individual color areas.

Therefore, the object of the invention is to develop a process for producing colored animal fodder or human food and similar things which allows a clearly delimited color distribution when extruded products are made with two or more colors. This is accomplished by the features of claim 1.

The animal fodder or human food is first prepared in the necessary manner in an extruder, for example, and then the desired colors are individually added, in a short mixing area, to the prepared product and mixed with it and then shaped or expanded through dies. Only once the individually premixed product/color flows have passed through the die are they brought together, without it still being possible for them to mix or run together.

Such inventive color delimitations can be produced on pellets or extruded/expanded products of the most various forms. For example, it is also possible for special additives such as vitamins or pharmaceuticals, for example, to be concentrated in specific areas of a product. This in turn makes it easier for such products to be sorted and made available. It is possible for colors or colored patterns to be aimed at deliberately stimulating the consumption of animal fodder or human food or at achieving a perception of a product.

The invention also relates to a device for producing colored animal fodder or human food or similar things. This is accomplished with the features of claim 6.

Pursuant to the invention, an area for preparation of the product is followed by a multiple-screw mixing area. The individual screws are spatially separated from one another, and each screw area corresponds to one color or one additive. The shafts merely mix the base material and the colorant or additive, and the product's properties are not influenced or are influenced to only a minimal extent. Only once the mixing products of the individual areas reach the area of an exit die are they brought together. Preferred embodiments are disclosed in the subordinate claims. It is preferred to use a twin-screw mixing area in combination with a die plate.

The invention is explained in greater detail below in a sample embodiment using drawings. In the associated drawings,

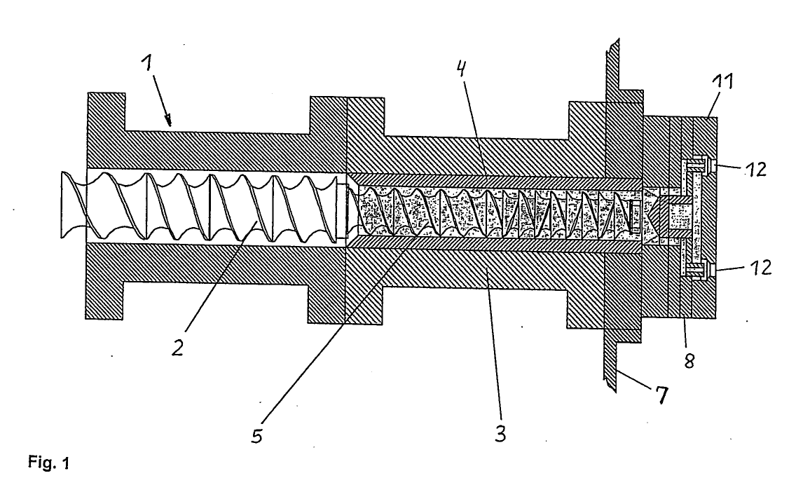

FIG. 1: shows a diagrammatic representation of a device for producing colored animal fodder or human food;

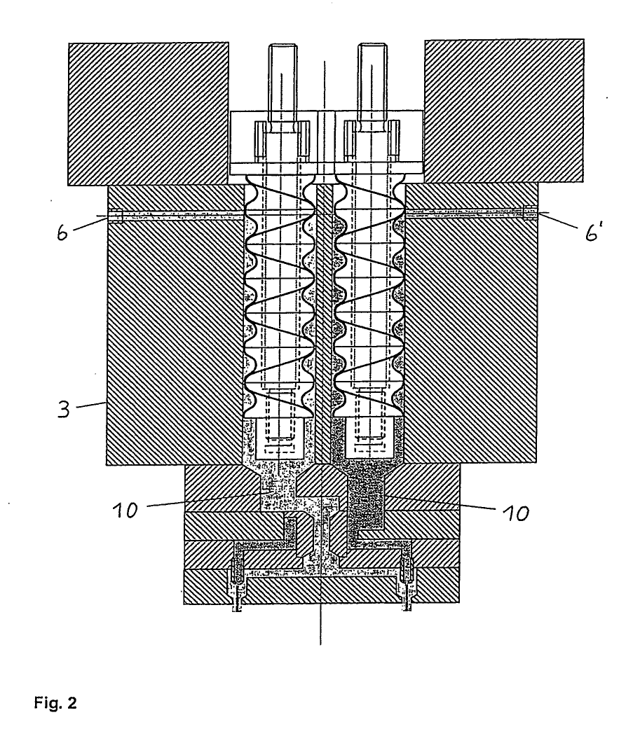

FIG. 2: shows a bicolor arrangement;

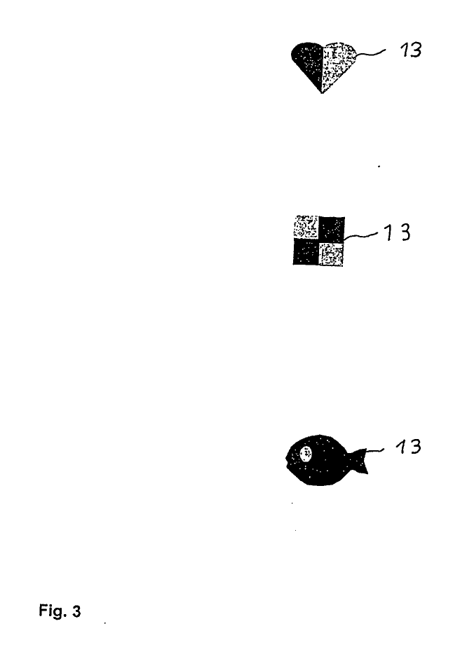

FIG. 3: shows examples of products that can be produced;

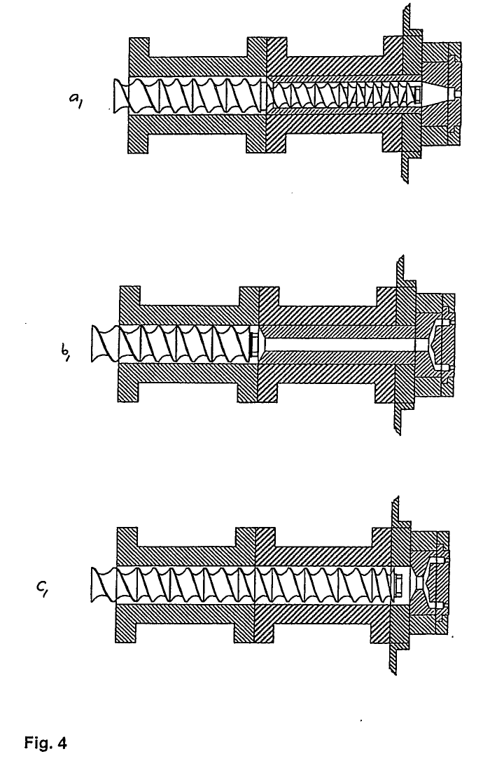

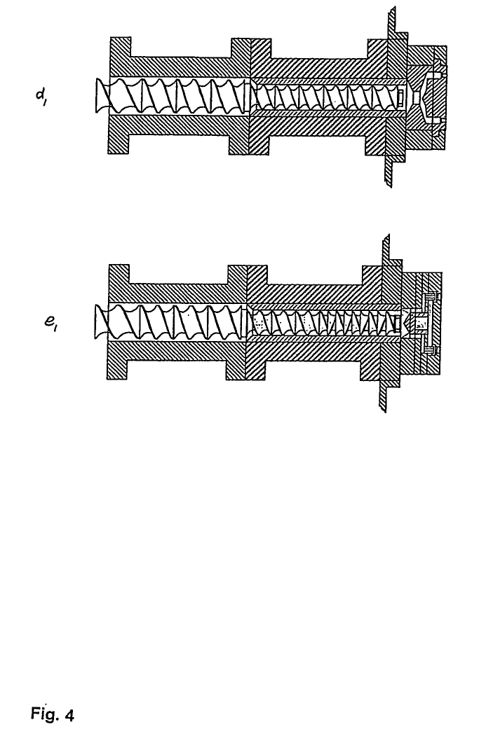

FIG. 4: shows other variant arrangements a through e.

A double-screw extruder 1 with mixing and kneading screws 2 has an additional mixing section 3 with two independent mixing chambers 4, each for one mixing screw 5 in the product flow direction. The mixing screws 5 have a smaller diameter than mixing and kneading screws 2 and serve exclusively to mix a colorant into the prepared product. The colorant is fed through a passage 6, 6′ into a mixing area, so that different colors cannot blend.

In the example, mixing section 3 is closed by an end plate 7, which is followed by a bicolor die 8. Die 8 consists of four plates (but there can also be fewer), which make it possible to control the two single-color product flows 10, 1O′. Only once the product flows 10, 10′ are in die plate 11 are they brought together in front of every individual die 12. In the case of marbled products, it would be possible for the partial flows to be brought together even earlier. When the joined product flows 10, 10′ exit from dies 12, they are usually cut and expanded into final products 13 with cleanly separated color areas. However, expansion is not strictly necessary.

The intermediate plates of bicolor die 8 have canals with slides and other cross section-modifying elements to control the flow which be rotated with respect to one another to make it possible to realize varied product shapes and color arrangements.

Mixing section 3 can have even more openings for the incorporation of other additives.

In the example, mixing section 3 is comparatively short and can also produce a product that is only marbled, if the mixing intensity and/or the length of the mixing screws 5 is reduced.

In the same way it is possible, by changing the structure of bicolor die 8, to produce traditionally expanded (FIG. 4 b, c) or marbled (FIG. 4 d) products, as well as extrudates with various blended colors (FIG. 4 a).

For products that are directly expanded in the traditional manner, it is possible for the screw and die plate to have arranged between them an intermediate piece with a tubular hole instead of the mixing section, or for the screw to be extended into mixing section 3.

For directly expanded products that are marbled, it is possible for the screw diameter to be reduced in the mixing section (as would also be possible in bicolor extrusion, FIG. 4 e), and for the die plate to contain an insert for dividing the product flow, as can be done in an analogous manner in traditional extrudates or bicolor extrusion.

For products with blended colors it is also possible for the screw diameter to be reduced in the mixing section, and an insert for dividing the flow can also be present.

1. Process for producing colored animal fodder or human food or similar things by means of extrusion with admixture of colorants to a product and extruding/expanding the product/colorant mixture, comprising providing a product flow, dividing the product flow, according to the number of different colorants, into independent partial flows, each of which has only one colorant admixed with it, bringing together the partial flows only shortly before they exit from a processing device so that the different color areas in the end product are preserved.

2. Process of claim 1, wherein two colorants are supplied.

3. Process of claim 1, wherein at least one partial flow has other substances added to it.

4. Process of claims 1, wherein each colorant is mixed with the partial flow by means of a separate mixing screw.

5. Process of claim 1, wherein the partial flows are brought together only shortly before expansion.

6. Device for producing colored animal fodder or human food or industrial products with an extruder/expander, comprising a die plate with several dies for the exit of a colored product, an extruder downstream in the product flow direction, a mixing section which has one mixing screw in a mixing chamber for each colorant, a following die arrangement, the die arrangement comprising canals which lead from the mixing chambers to the dies of a die plate.

7. Device of claim 5, wherein the canals of the various independent mixing chambers are brought together only shortly before the die plate.

8. Device of claim 5 wherein the mixing section comprises two mixing chambers.

9. Device of claim 5, wherein the canals have cross section-modifying and flow controlling elements.
